(19) United States
(12) Patent Application Publication
(10) Pub. No.: US 2020/0264483 A1
(43) Pub. Date: Aug. 20, 2020

(54) DISPLAY PANEL AND FABRICATION METHOD THEREOF, AND DISPLAY APPARATUS

(71) Applicants: BOE TECHNOLOGY GROUP CO., LTD., Beijing (CN); BEIJING BOE DISPLAY TECHNOLOGY CO., LTD., Beijing (CN)

(72) Inventors: Yanping LIAO, Beijing (CN); Xibin SHAO, Beijing (CN); Xueqiang QIAN, Beijing (CN)

(21) Appl. No.: 16/062,762

(22) PCT Filed: Nov. 24, 2017
(86) PCT No.: PCT/CN2017/112820

§ 371 Date: Jun. 15, 2018

(30) Foreign Application Priority Data
May 12, 2017 (CN) 201720538622.9

(51) Int. Cl. G02F 1/1362; G02F 1/1333; G02F 1/1339

(52) U.S. Cl. CPC G02F 1/136209; G02F 2001/133334; G02F 1/1339; G02F 1/133308

(57) ABSTRACT

A display panel and a fabrication method thereof, and a display apparatus are provided. The display panel includes an opposed substrate and an array substrate which are arranged opposite to and bonded with the opposed substrate, a conductive black matrix is arranged on a side of the opposed substrate, and the black matrix is electrically connected with an external circuit and then is grounded.

### CROSS-REFERENCE TO RELATED PATENT APPLICATIONS

The present application is a U.S. National Stage Application under 35 U.S.C. § 371 of International Patent Application No. PCT/CN2017/112820, filed Nov. 24, 2017, which claims the benefit of priority under 35 U.S.C. Section 119(e) of Chinese Patent Application No. 201720538622.9 filed on May 12, 2017, the disclosure of which are incorporated herein by reference in their entireties as part of the present application.

### TECHNICAL FIELD

At least one embodiment of the present disclosure relates to a technical field of display, and particularly, to a display panel and a fabrication method thereof, and a display apparatus.

### BACKGROUND

Currently, a liquid crystal display apparatus is widely applied in the field of display due to advantages of ultra-thin thickness, light weight, low power consumption and the like. The liquid crystal display apparatus controls an orientation direction of liquid crystal molecules in a liquid crystal layer by applying an appropriate voltage to the liquid crystal layer through an electrode, so as to display an image. In the liquid crystal display apparatus, in order to avoid interference of an external field to the orientation direction of liquid crystal molecules, a shielding structure needs to be arranged so as to shield the external field and avoid interference of the external field to liquid crystal display.

However, the display apparatus and a display panel included in the display apparatus still need to be improved.

### SUMMARY

According to the embodiments of the disclosure, a display panel is provided. The display panel comprises: an opposed substrate, a conductive black matrix being arranged on a side of the opposed substrate; and an array substrate, arranged opposite to and bonded with the opposed substrate. The black matrix is electrically connected with an external circuit.

For example, a resistivity of the black matrix is 3,000 to 105 Ω·cm.

For example, the black matrix includes molybdenum oxide.

For example, the external circuit is grounded.

For example, the display panel further comprises: an electromagnetic shielding structure, including the black matrix, a bonding portion and a connection portion. The bonding portion is electrically connected with the black matrix and the connection portion, and the connection portion is connected with the external circuit.

For example, the display panel further comprises: a sealant portion, arranged between the opposed substrate and the array substrate. A sealed space is formed by the sealant portion, the opposed substrate and the array substrate.

For example, the black matrix extends to a side of the sealant portion, which faces away from the sealed space; and the bonding portion and the connection portion are arranged on the side of the sealant portion, which face away from the sealed space.

For example, the bonding portion is connected with a portion, which extends to the side of the sealant portion facing away from the sealed space, of the black matrix.

For example, the connection portion is arranged on a side of the bonding portion, which faces away from the sealant portion.

For example, the connection portion and the binding portion are positioned between the black matrix and the array substrate, and the connection portion is arranged on a side of the bonding portion, which faces away from the black matrix.

For example, the sealant portion is a conductive sealant, the conductive sealant forms the bonding portion, one end of the conductive sealant is connected with the black matrix, and the other end of the conductive sealant is connected with the connection portion.

For example, the array substrate further includes a lead wire, the lead wire extends to the side of the sealant portion, which faces away from the sealed space, and the lead wire forms the connection portion.

For example, the bonding portion includes a conductive adhesive, and the connection portion includes conductive foam.

According to the embodiments of the disclosure, a display apparatus comprising the display panel as described above is provided.

For example, the display apparatus further comprises a conductive frame arranged to surround the display panel. The black matrix is electrically connected with the conductive frame.

According to the embodiments of the disclosure, a fabrication method of a display panel is provided. The method comprises: providing an array substrate and an opposed substrate which are arranged opposite to and bonded with each other; and forming a conductive black matrix on a side of the opposed substrate. The black matrix is electrically connected with an external circuit.

For example, the fabrication method further comprises: forming an electromagnetic shielding structure, which includes the black matrix, a bonding portion and a connection portion. The bonding portion is connected with the black matrix and the connection portion, and the connection portion is connected with the external circuit.

For example, the fabrication method further comprises: forming a sealant portion between the array substrate and the opposed substrate. A sealed space is formed by the sealant portion, the opposed substrate and the array substrate.

For example, the forming the electromagnetic shielding structure includes: forming the black matrix to extend to a side of the sealant portion, which faces away from the sealed space; forming the bonding portion on the side of the sealant portion, which faces away from the sealed space, and connecting the bonding portion with the black matrix; and forming the connection portion on a side of the bonding portion, which faces away from the sealant portion.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1 shows a structural schematic view of a display panel according to embodiments of the present disclosure;

FIG. 2 shows another structural schematic view of the display panel according to the embodiments of the present disclosure;

FIG. 3A to FIG. 3C show still another structural schematic views of the display panel according to the embodiments of the present disclosure;

FIG. 4 shows a structural schematic view of a display apparatus according to the embodiments of the present disclosure;

FIG. 5 shows another structural schematic view of the display apparatus according to the embodiments of the present disclosure; and

FIG. 6A to FIG. 6D are flow views of a fabrication method of a display panel according to the embodiments of the present disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. It is obvious that the described embodiments are just a part but not all of the embodiments of the disclosure. Based on the described embodiments herein, those skilled in the art can obtain other embodiment(s), without any inventive work, which should be within the scope of the disclosure.

Unless otherwise defined, the technical terms or scientific terms here should be of general meaning as understood by those ordinarily skilled in the art. In the descriptions and claims of the present disclosure, expressions such as “first”, “second” and the like do not denote any order, quantity, or importance, but rather are used for distinguishing different components. Expressions such as “include” or “comprise” and the like denote that elements or objects appearing before the words of “include” or “comprise” cover the elements or the objects enumerated after the words of “include” or “comprise” or equivalents thereof, not exclusive of other elements or objects. Expressions such as “connect” or “interconnect” and the like are not limited to physical or mechanical connections, but may include electrical connections, whether direct or indirect. Expressions such as “up”, “down”, “left”, “right” and the like are only used for expressing relative positional relationship, the relative positional relationship may be correspondingly changed in the case that the absolute position of a described object is changed.

A display panel generally has problems of high cost, complex process and the like in the process of implementing electromagnetic shielding. For example, the electromagnetic shielding effect of the display panel is achieved mainly by depositing an Indium Tin Oxide (ITO) layer on an outer side of an opposed substrate, connecting the ITO layer with an external circuit by a conductive foam and the like and grounding the external circuit. However, the ITO layer is relatively high in cost, and deposition of the ITO layer needs an additional production process. Therefore, if the structure of the display panel is improved (for example, design of related structures for electromagnetic shielding is simplified), the problems of high production cost and complex production process of the display panel can be solved.

At least one embodiment of the present disclosure provides a display panel. The display panel includes: an opposed substrate, a black matrix being arranged on a side of the opposed substrate, and an array substrate, arranged opposite to and bonded with the opposed substrate; and the black matrix is configured to be electrically connected with an external circuit. The display panel implements electromagnetic shielding function by the conductive black matrix with electrical conductivity, so that production cost can be reduced and production flow can be simplified.

It should be noted that in the embodiments of the present disclosure, the type of the display panel is not limited. For example, the display panel is a liquid crystal display panel, and correspondingly, the opposed substrate for example is a color filter substrate. For example, the display panel is an organic light-emitting diode display panel, and correspondingly, the opposed substrate for example is a package cover plate and the like. The technical solutions in the following embodiments of the present disclosure will be described by taking a case that the display panel is the liquid crystal display panel as an example.

The display panel, a fabrication method of the display panel and a display apparatus comprising the display panel according to at least one embodiment of the present disclosure will be described in detail below in connection of the drawings.

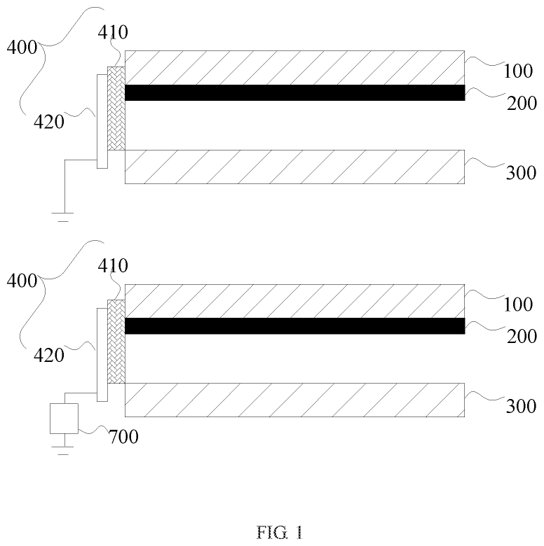

FIG. 1 shows a structural schematic view of the display panel according to the embodiments of the present disclosure. For example, as shown in FIG. 1, in at least one embodiment of the present disclosure, the display panel includes an opposed substrate 100 and an array substrate 300 which are arranged opposite to and bonded with each other, a conductive black matrix 200 is arranged on a side of the opposed substrate 100, and the black matrix is configured to be electrically connected with an external circuit 700. The black matrix 200 arranged on the opposed substrate 100 is further configured to prevent light leakage of the display panel. The opposed substrate 100 and the array substrate 300 are arranged opposite to and bonded with each other, and a sealed space for accommodating liquid crystal molecules is formed between the opposed substrate 100 and the array substrate 300. Those skilled in the art should understand that before the opposed substrate 100 and the array substrate 300 are bonded with each other, the liquid crystals need to be dropped onto the array substrate 300 so as to achieve a display function of the display panel. The black matrix 200 is arranged on the opposite substrate 100 and is connected to the external circuit 700; and in this case, if a high-level voltage is generated on the black matrix 200, charges for generating the high level are released into the external circuit 700, so that the black matrix 200 takes an electromagnetic shielding function on an internal structure of the display panel. Therefore, with respect to the structure of depositing the ITO layer on the opposite substrate, the ITO layer and the like do not need to be provided for the purpose of achieving the electromagnetic shielding effect in the display panel according to the embodiments of the disclosure, so that production cost can be reduced, and production flow can be simplified.

In the embodiments of the present disclosure, a specific arrangement position of the black matrix 200 is not limited. For example, the black matrix 200 is arranged on a side of the opposed substrate 100, which faces the array substrate 300; or, the black matrix 200 is arranged on a side of the opposed substrate 100, which faces away from the array substrate 300.

In the embodiments of the present disclosure, a material of the black matrix 200 is not limited, and for example, the black matrix 200 is configured to have electrical conductivity and thus serve as an electrode structure for electromagnetic shielding. For example, the black matrix 200 according to the embodiments of the present disclosure is a black matrix with a low resistivity or a medium resistivity.

For example, in at least one embodiment of the present disclosure, the resistivity of the black matrix 200 is about 3,000 to 10⁵ Ω·cm. According to the embodiments of the present disclosure, in the case that the resistivity of the black matrix is in the above range, the black matrix 200 has electrical conductivity. Therefore, the black matrix 200 serves as the shielding electrode instead of the ITO layer arranged on the opposed substrate, so as to implement electromagnetic shielding. In the case that the resistivity of the black matrix is in the above range, not only the black matrix is guaranteed to have sufficient electrical conductivity and be used for implementing electromagnetic shielding, but also increase of material cost, which is caused by excessive pursuit for the electrical conductivity, is avoided. It should be noted that the resistivity of the black matrix 200 is not limited to the above range, as long as the resistivity of the black matrix 200 meets requirements for implementing electromagnetic shielding.

In the embodiments of the present disclosure, the material of the black matrix 200 is not limited. For example, the black matrix 200 is formed by a low-resistivity material, or is formed by adding a conductive material in a resin and the like, as long as the resistivity of the black matrix 200 meets requirements, and the embodiments of the present disclosure do not limit the specific material of the black matrix 200. For example, the material of the black matrix 200 include molybdenum oxide, and for example, the molybdenum oxide is added in the resin. For example, the molybdenum oxide in the black matrix 200 is molybdenum trioxide (MoO₃) or molybdenum dioxide (MoO₂) and the like. Therefore, electromagnetic shielding is implemented by adopting the low-cost material.

According to the embodiments of the present disclosure, the black matrix 200 is adopted to replace the ITO layer to implement electromagnetic shielding, not only the production cost is reduced (because the cost of the ITO layer is relatively high), but also the production process is simplified. Specifically, in consideration of preventing light leakage, the black matrix needs to be arranged on the opposed substrate. Therefore, in the case that the black matrix 200 is further used for electromagnetic shielding, additional production process does not need to be provided. In addition, those skilled in the art should understand that in the display panel, each pixel unit comprises a part of the black matrix so as to cover an electrical line and shield uncontrolled portions of the liquid crystal molecules, thereby preventing light leakage; and in this case, the black matrix 200 does not cover the whole surface of the opposed substrate 100, but distribution of the black matrix 200 on the opposed substrate 100 is relatively uniform. Therefore, the black matrix 200 has an excellent electromagnetic shielding effect on the display panel.

In the embodiments of the present disclosure, the region where the black matrix 200 is arranged is a region in which light from a backlight does not need to be passed, and thus, in the case that the black matrix 200 is utilized to carry out electromagnetic shielding, the utilization rate of the backlight of the display panel is not influenced. Compared to the display panel in which the ITO layer is deposited to form the electromagnetic shielding structure, the display panel according to the embodiments of the present disclosure does not introduce an additional structure (for example, the ITO layer). Although the ITO layer has excellent transmittance, introduction of the additional ITO layer reduces the transmittance of the display panel; and in this case, in order to enable the display panel to have sufficient brightness, light intensity of the backlight has to be increased and thus increase of power consumption of the display panel is caused. In the embodiments of the disclosure, adopting the black matrix 200 to implement electromagnetic shielding at least have the advantages as follows: cost is low, and the display panel does not need expensive raw materials; the preparation process is simple, the display panel does not need an additional production process for forming the black matrix 200; and a display function of the display panel is not influenced, and shielding of an external electric field is implemented in the premise of not increasing power consumption of the display panel.

For example, in the display panel provided by the embodiments of the present disclosure, the external circuit 700 is configured to be grounded. Therefore, grounding (for example, electrically grounding) of the black matrix is implemented by utilizing the external circuit, and charges aggregated in the black matrix and even in the display panel are released out, so as to protect the display panel. The solution in at least one embodiment of the present disclosure will be described below by taking a case that the external circuit is configured to be grounded as an example.

In the embodiments of the present disclosure, a specific mode of electrical connection between the black matrix 200 and the external circuit 700 is not limited. For example, in at least one embodiment of the present disclosure, as shown in FIG. 1, the display panel includes an electromagnetic shielding structure 400, the electromagnetic shielding structure 400 includes the black matrix 200, a bonding portion 410 and a connection portion 420, the bonding portion 410 is electrically connected with the black matrix 200 and the connection portion 420, and the connection portion 420 is connected with the external circuit 700. Therefore, the electrical connection between the black matrix 200 and the external circuit 700 is implemented, so that the black matrix 200 carries out the electromagnetic shielding protection on the display panel.

Those skilled in the art should understand that the electromagnetic shielding structure 400 according to the embodiments of the present disclosure needs to be grounded so as to shield the external electrical field. In the embodiments of the present disclosure, a specific mode for grounding the electromagnetic shielding structure 400 is not limited, and those skilled in the art should select according to practical situations. For example, the black matrix 200 is electrically connected with the external circuit 700 by utilizing an adhesive with a certain conductivity, such as a conductive adhesive and the like, or the black matrix 200 is directly connected with a metal structure, so that grounding of the black matrix 200 is implemented. According to the embodiments of the present disclosure, the black matrix 200 is electrically connected with the connection portion 420 by the bonding portion 410, and then is electrically connected with an external grounding circuit 700 or other grounding structures by the connection portion 420 so as to simply and conveniently implement grounding.

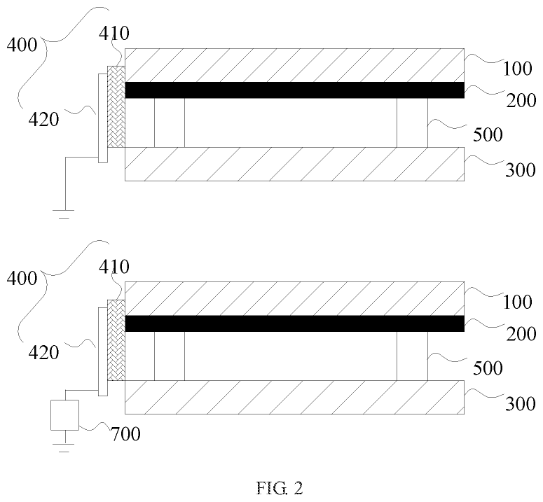

FIG. 2 shows another structural schematic view of the display panel according to the embodiments of the present disclosure. For example, as shown in FIG. 2, the connection portion 420 and the bonding portion 410 are arranged on an side surface (i.e., a position which is at a side portion of the display panel and corresponds to a liquid crystal accommodating space between the opposed substrate 100 and the array substrate 300) of the display panel, and grounding of the black matrix 200 is implemented by the connection at the side surface.

For example, the display panel provided by at least one embodiment of the present disclosure further includes a sealant portion, the sealant portion is arranged between the opposed substrate and the array substrate, and a sealed space is formed by the sealant portion, the opposed substrate and the array substrate. Exemplarily, as shown in FIG. 2, the display panel further includes a sealant portion 500. The sealant portion 500 is arranged between the opposed substrate 100 and the array substrate 300, and a sealed space is formed by the sealant portion 500, the opposed substrate 100 and the array substrate 300. Specifically, during preparing the display panel, the opposed substrate 100 and the array substrate 300 which are opposite to each other are tightly bonded with each other by respectively coating a sealant at edges (sealant coating regions) of the opposed substrate 100 and the array substrate 300, and thus the sealant portion 500 is formed and the liquid crystal molecules filled between the two substrates (i.e. the opposed substrate 100 and the array substrate 300) are surrounded by the sealant portion 500 and spaced apart from the outside by the sealant portion 500. In other words, the sealant portion 500 is provided at the periphery of the display panel to limit the liquid crystal molecules in the display panel.

For example, in the display panel provided by at least one embodiment of the present disclosure, the black matrix extends to a side of the sealant portion, which faces away from the sealed space, and the bonding portion and the connection portion are arranged on the side of the sealant portion, which faces away from the sealed space. Exemplarily, as shown in FIG. 2, the black matrix 200 extends beyond the sealant portion 500, i.e., extends to the side of the sealant portion 500 facing away from the sealed space for accommodating the liquid crystal molecule. Therefore, the connection between the black matrix and the external circuit is carried out and the grounding of the black matrix are implemented outside the sealed space. For example, in the display panel provided by at least one embodiment of the present disclosure, the bonding portion is connected with a portion of the black matrix, which extends to the side of the sealant portion facing away from the sealed space. Therefore, the bonding portion 410 is in direct contact with the portion of the black matrix 200, which protrudes out of the sealant portion 500, so as to facilitate the connection between the bonding portion 410 and the black matrix 200. The bonding portion 410 and the connection portion 420 are arranged on an outer side of the sealant portion 500 (that is, the bonding portion 410 and the connection portion 420 are arranged out of the sealed space), and thus the connection between the electromagnetic shielding structure and the external circuit is implemented in the premise of not influencing the bonding of the array substrate and the opposed substrate, so as to further implement grounding of the electromagnetic shielding structure. Therefore, the grounding connection of the black matrix 200 is implemented on the side surface of the liquid crystal panel, and a volume of the display panel is not increased.

For example, in the display panel provided by at least one embodiment of the present disclosure, the connection portion is arranged on a side of the bonding portion, which faces away from the sealant portion. Exemplarily, as shown in FIG. 2, the bonding portion 410 is connected with the portion of the black matrix 200, which extends out of the sealant portion 500 (on the side of the sealant portion 500 facing away from the sealed space), and for example, the bonding portion 410 is arranged on the side of the sealant portion 500, which faces away from the sealed space. The grounding of the black matrix is implemented on the side surface of the display panel by arranging the bonding portion 410 on the outer side of the sealant portion 500, and thus the connection mode is simple in structure and the preparation process of the display panel is simplified.

For example, in at least one embodiment of the present disclosure, as shown in FIG. 2, the bonding portion 410 is positioned on the side of the sealant portion 500, which faces away the sealed space, and fills up a gap between the array substrate 300 and the opposed substrate 100. Therefore, a contact area between the bonding portion 410 and the black matrix 200 is increased so as to ensure electrical connection between the bonding portion 410 and the black matrix 200.

For example, the display panel needs to be assembled and fixed with structures such as a backlight module and the like in the later assembling process, and thus, a frame, e.g., a metal frame of the backlight module (such as an iron frame and the like), for assembling and fixing is arranged at the side surface of the display panel. In this case, the connection portion 420 is arranged between the bonding portion 410 and a conductive frame (e.g., the metal frame), so that the grounding of the black matrix 200 is implemented, and a grounding circuit does not need to be additionally arranged.

In the embodiments of the present disclosure, materials for forming the bonding portion 410 and the connection portion 420 are not limited. For example, in at least one embodiment of the present disclosure, the bonding portion 410 includes a conductive adhesive (e.g., a conductive silver adhesive and the like), and the connection portion 420 includes a conductive foam. Therefore, the conductive adhesive is grounded by the conductive foam adhered to the outer side of the conductive adhesive so as to shield the external electric field. Moreover, the above-mentioned materials for forming the electromagnetic shielding structure are wide in source and easy to obtain, so that production cost can be saved.

It should be noted that in the embodiments of the present disclosure, positions of the bonding portion and the connection portion are not limited to FIG. 2, and the embodiments of the present disclosure do not limit a position relationship of the bonding portion and the connection portion, as long as the bonding portion and the connection portion electrically connect the black matrix with the external circuit.

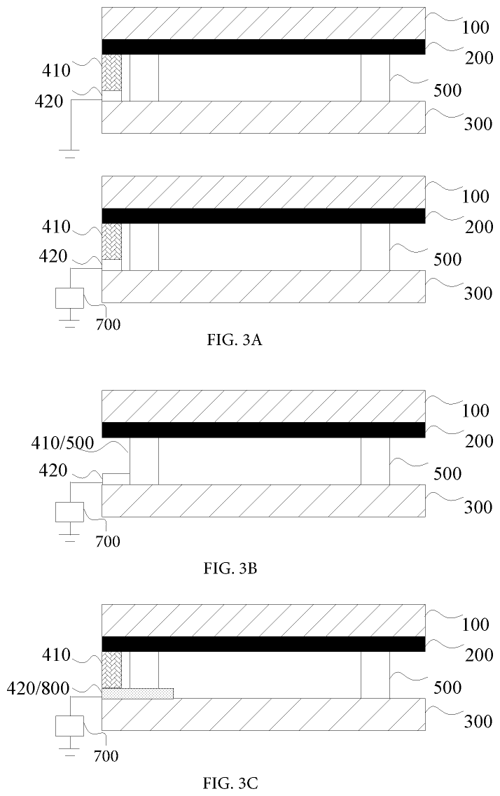

For example, in at least one embodiment of the present disclosure, the connection portion and the bonding portion are positioned between the black matrix and the array substrate, and the connection portion is arranged on a side of the bonding portion, which faces away from the black matrix. FIG. 3A to FIG. 3C show still another structural schematic views of the display panel according to the embodiments of the present disclosure. For example, as shown in FIG. 3A, the grounding of the electromagnetic shielding structure 400 is implemented in a surface connection mode on a side of the array substrate 300. Exemplarily, the connection portion 420 and the bonding portion 410 are positioned between the black matrix 200 and the array substrate 300, and the connection portion 420 is arranged on a side of the bonding portion 410, which faces away from the black matrix 200. Therefore, the connection portion 420 and the bonding portion 410 are both arranged between the opposed substrate 100 and the array substrate 300 without increasing a width of a frame region of the display panel, which is beneficial to the design of narrowing the frame of the display panel; furthermore, the connection portion 420 and the bonding portion 410 cannot be damaged by an external component or an external force because of the protection of the opposed substrate 100 and the array substrate 300, thereby ensuring reliability of connection among the black matrix 200, the bonding portion 410 and the connection portion 420.

For example, in at least one embodiment of the present disclosure, as shown in FIG. 3B, the sealant portion 500 is configured as a conductive sealant, the conductive sealant forms the bonding portion 410, one end of the conductive sealant is connected with the black matrix 200, and the other end of the conductive sealant is connected with the connection portion 420. Exemplarily, conductive particles (e.g., the conductive silver adhesive and the like) are doped in the sealant portion 500, and the end of the sealant portion 500 is electrically connected with the connection portion 420; and in this case, in the process of bonding the array substrate 300 and the opposed substrate 100, the sealant portion 500 directly and electrically connects the black matrix 200 with the external circuit 700, thereby simplifying the fabrication process of the display panel.

For example, in at least one embodiment of the present disclosure, as shown in FIG. 3C, the array substrate further includes a lead wire 800, the lead wire 800 extends to the side of the sealant portion, which faces away from the sealed space, and the lead wire 800 forms the connection portion 420. Therefore, the conductive foam does not need to be additionally arranged so as to simplify the structure of the display panel.

Exemplarily, as shown in FIG. 3C, a plurality of thin film transistors (TFTs) for controlling the liquid crystal molecules are arranged on the array substrate 300, and correspondingly, a plurality of lead wires 800 are provided at a portion of the array substrate 300 on the outer side of the sealant portion 500, for implementing electrical connection between electrical components (such as the TFTs and the like) on the array substrate 300 and the control circuit (e.g., a flexible circuit board, a control Integrated Circuit (IC) and the like). For example, the grounding of the black matrix 200 is implemented by utilizing the above-mentioned inherent structure (i.e. the lead wire 800) on the array substrate 300. For example, as shown in FIG. 3C, the lead wire 800 is adopted to form the connection portion 420, and the lead wire 800 extends to the side of the sealant portion 500, which faces away from the sealed space. Meanwhile, the black matrix 200 also extends to the side of the sealant portion 500, which faces away from the sealed space. For example, the conductive adhesive is coated at a position of the black matrix 200, which corresponds to the lead wire 800 that needs to be connected with the black matrix 200, so that after the opposed substrate 100 and the array substrate 300 are bonded with each other, electrical connection between the black matrix 200 and the lead wire 800 is implemented. In this case, the shielding of the electromagnetic shielding structure 400 on the external electrical field is implemented by utilizing the lead wire 800 to connect the black matrix 200 with the external grounding circuit 700. For example, according to the embodiments of the present disclosure, before the opposed substrate 100 and the array substrate 300 are bonded with each other, the conductive adhesive is dropped on the portion, which is positioned on the outer side of the sealant portion 500 (that is, on the side of the sealant portion 500, which faces away from the sealed space), of the black matrix 200 on the opposed substrate 100 in the process of coating the sealant or after the sealant is coated. Therefore, the black matrix 200 is connected with the lead wire 800 by utilizing the conductive adhesive in the bonding process and then is connected with the external circuit 700 by the lead wire 800 and grounded so as to form the electromagnetic shielding structure. Therefore, the conductive foam does not need to be additionally arranged so as to simplify the structure of the display panel.

At least one embodiment of the present disclosure provides a display apparatus. The display apparatus includes the display panel in any one of the above-mentioned embodiments. Therefore, production cost of the display apparatus can be reduced, and production flow can be simplified.

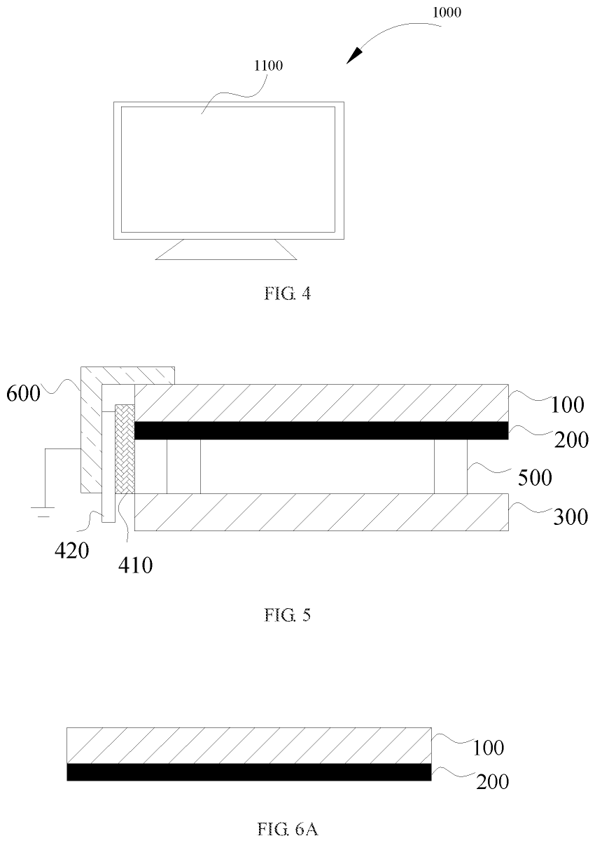

For example, in the display apparatus provided by at least one embodiment of the present disclosure, FIG. 4 shows a structural schematic view of the display apparatus according to at least one embodiment of the present disclosure. For example, as shown in FIG. 4, the display apparatus 1000 includes a display panel 1100, and the display panel 1100 is the display panel in any one of the above-mentioned embodiments, and thus, the display apparatus 1000 has all the characteristics and advantages of the above-mentioned display panel, which are not repeated herein. For example, the display apparatus has at least one of the advantages as follows: cost is low, and expensive raw materials are not needed; the preparation process is simple, and an additional production process for forming the black matrix 200 are not needed; and a display function of the display apparatus is not influenced, and shielding of the external electric field is implemented in the premise of not increasing power consumption of the display apparatus.

For example, in the display apparatus provided by at least one embodiment of the present disclosure, FIG. 5 shows another structural schematic view of the display apparatus according to at least one embodiment of the present disclosure. For example, as shown in FIG. 5, the display apparatus 1000 further includes a metal frame 600, the metal frame 600 for example is arranged to surround the display panel, and the connection portion 420 is connected with the metal frame 600. Therefore, the grounding of the black matrix 200 is simply and conveniently implemented by utilizing the metal frame so as to shield the external electric field. It should be noted that the metal frame 600 may be replaced with other conductive frames, and the embodiments of the present disclosure do not limit it.

For example, the display apparatus may be any one of products or parts with the display function, such as a television, a digital camera, a mobile phone, a watch, a tablet personal computer, a notebook computer, a navigator and the like.

At least one embodiment of the present disclosure provides a fabrication method of a display panel. The method includes: providing an array substrate and an opposed substrate which are arranged opposite to and bonded with each other; and forming a conductive black matrix on a side of the opposed substrate; and the black matrix is electrically connected with an external circuit. As for the above fabrication method, the obtained display panel implements electromagnetic shielding by the black matrix with an electrical conductivity, production cost can be reduced, and production flow can be simplified.

For example, the fabrication method of the display panel, which is provided by at least one embodiment of the present disclosure, further includes: forming an electromagnetic shielding structure including the black matrix, a bonding portion and a connection portion, the bonding portion is connected with the black matrix and the connection portion, and the connection portion is connected with the external circuit. The black matrix of the electromagnetic shielding structure is electrically connected with the external circuit so that the black matrix has the electromagnetic shielding function.

For example, the fabrication method of the display panel, which is provided by at least one embodiment of the present disclosure, further includes: forming a sealant portion between the array substrate and the opposed substrate, and a sealed space is formed by the sealant portion, the opposed substrate and the array substrate. By utilizing the sealant portion, the array substrate and the opposed substrate are bonded with each other, and an internal structure of the display panel provided in the sealed space is protected.

For example, in the fabrication method of the display panel, which is provided by at least one embodiment of the present disclosure, the forming the electromagnetic shielding structure includes: forming the black matrix to extend to a side of the sealant portion, which faces away from the sealed space; forming the bonding portion on the side of the sealant portion, which faces away from the sealed space, and connecting the bonding portion with the black matrix; and forming the connection portion on a side of the bonding portion, which faces away from the sealant portion. Therefore, the black matrix is electrically connected with the external circuit on the premise of not influencing the bonding of the opposed substrate and the array substrate.

It should be noted that a specific structure of the display panel obtained by utilizing the fabrication method may refer to related contents in the foregoing embodiments (the embodiments related to the display panel), which is not repeated herein. Moreover, for various different structures of display panels in the foregoing embodiments, the fabrication method of the display panel may correspondingly regulated, and the embodiments of the present disclosure do not repeat it herein.

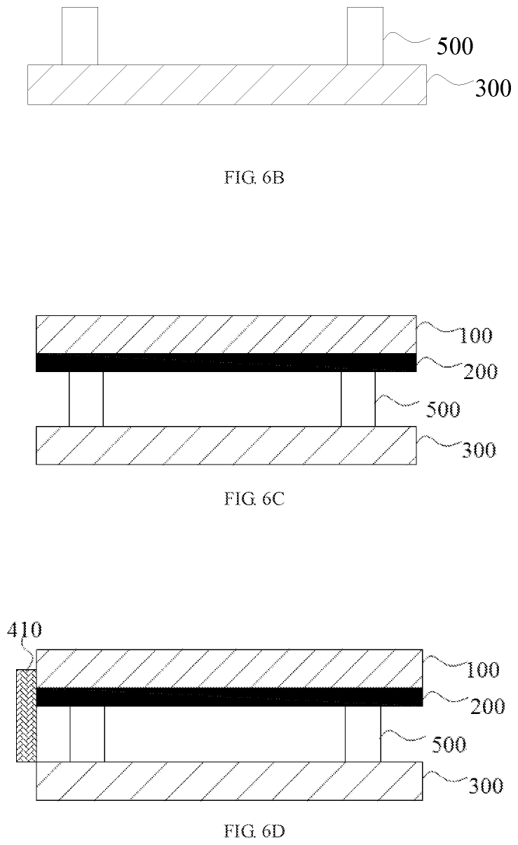

FIG. 6A to FIG. 6D are process views of the fabrication method of the display panel, which is provided by at least one embodiment of the present disclosure. In at least one embodiment of the present disclosure, as shown in FIG. 6A to FIG. 6D, the fabrication method of the display panel will be illustrated below by taking the display panel as shown in FIG. 2 as an example.

As shown in FIG. 6A, the opposed substrate 100 is provided, and the black matrix 200 is formed on the side of the opposed substrate 100.

As shown in FIG. 6B, the array substrate 300 is provided, and the sealant portion 500 is formed on the array substrate.

It should be noted that the sealant portion 500 is not limited to be formed on the array substrate 300 and may be formed on the opposed substrate 100, and the embodiments of the present disclosure do not repeat it herein.

As shown in FIG. 6C, the opposed substrate 100 and the array substrate 300 are bonded with each other, and the sealant portion 500 is positioned between the opposed substrate 100 and the array substrate 300 so as to bond the opposed substrate 100 with the array substrate 300.

It should be noted that in the embodiments of the present disclosure, a specific position of the black matrix 200 is not limited. The black matrix 200 is formed on the side of the opposed substrate 100, which faces the array substrate 300, or the black matrix 200 is formed on the side of the opposed substrate 100, which faces away from the array substrate 300. The technical solutions in the following embodiments of the present disclosure will be illustrated below by taking a case that as shown in FIG. 6C, the black matrix 200 is formed on the side of the opposed substrate 100, which faces the array substrate 300, as an example.

For example, the black matrix 200 is formed to extend to the side of the sealant portion 500, which faces away from the sealed space.

As shown in FIG. 6D, the bonding portion 410 is formed on the side of the sealant portion 500, which faces away from the sealed space. The bonding portion 410 is electrically connected with the black matrix 200.

As shown in FIG. 2, the connection portion 420 is formed on the side of the bonding portion 410, which faces away from the sealant portion 500, and the connection portion 420 is connected with the external circuit 700 so that the black matrix 200 is electrically connected with the external circuit 700.

It should be noted that in the embodiments of the present disclosure, before the opposed substrate 100 and the array substrate 300 are bonded with each other, a stack of the bonding portion 410 and the connection portion 420 as shown in FIG. 3A is formed for example on the array substrate and is provided on the outer side of the sealant portion 500. Then the opposed substrate 100 and the array substrate 300 are bonded with each other, the connection portion 420 and the bonding portion 410 are positioned between the black matrix 200 and the array substrate 300, and the connection portion 420 is arranged on the side of the bonding portion 410, which faces away from the black matrix 200.

For example, the sealant portion is a conductive sealant, the conductive sealant forms the bonding portion, one end of the conductive sealant is connected with the black matrix, and the other end of the conductive sealant is connected with the connection portion. Conductive particles (e.g., a conductive silver adhesive and the like) for example are doped in the sealant portion and one end of the sealant portion is electrically connected with the connection portion, so that in the process of bonding the array substrate and the opposed substrate, the sealant portion directly and electrically connects the black matrix with the external circuit, thereby simplifying the preparation process of the display panel.

For the embodiments of the present disclosure, several points below still should be noted:

(1) The drawings of the embodiments of the present disclosure are only related to structures to which the embodiments of the present disclosure relate, and other structures can refer to general design.

(2) For clarity, in the drawings for describing the embodiments of the present disclosure, a thickness of a layer or a region is amplified or reduced, i.e., those drawings are not drawn according to an actual scale.

(3) In case of no conflict, the embodiments of the present disclosure and the characteristics in the embodiments can be combined with each other to obtain new embodiments.

The foregoing embodiments merely are specific embodiments of the disclosure, and not intended to define the scope of the disclosure, and the scope of the disclosure should be determined by the scope of the claims.

1. A display panel, comprising:
an opposed substrate, a conductive black matrix being arranged on a side of the opposed substrate; and
an array substrate, arranged opposite to and bonded with the opposed substrate,
wherein the black matrix is electrically connected with an external circuit.

2. The display panel according to claim 1, wherein a resistivity of the black matrix is 3,000 to 10⁵ Ω·cm.

3. The display panel according to claim 1, wherein the black matrix includes molybdenum oxide.

4. The display panel according to claim 1, wherein the external circuit is grounded.

5. The display panel according to claim 1, further comprising:
an electromagnetic shielding structure, including the black matrix, a bonding portion and a connection portion,
wherein the bonding portion is electrically connected with the black matrix and the connection portion, and the connection portion is connected with the external circuit.

6. The display panel according to claim 5, further comprising: a sealant portion, arranged between the opposed substrate and the array substrate, wherein a sealed space is formed by the sealant portion, the opposed substrate and the array substrate.

7. The display panel according to claim 6, wherein the black matrix extends to a side of the sealant portion, which faces away from the sealed space; and the bonding portion and the connection portion are arranged on the side of the sealant portion, which face away from the sealed space.

8. The display panel according to claim 7, wherein the bonding portion is connected with a portion, which extends to the side of the sealant portion facing away from the sealed space, of the black matrix.

9. The display panel according to claim 7, wherein the connection portion is arranged on a side of the bonding portion, which faces away from the sealant portion.

10. The display panel according to claim 7, wherein the connection portion and the binding portion are positioned between the black matrix and the array substrate, and the connection portion is arranged on a side of the bonding portion, which faces away from the black matrix.

11. The display panel according to claim 6, wherein the sealant portion is a conductive sealant, the conductive sealant forms the bonding portion, one end of the conductive sealant is connected with the black matrix, and the other end of the conductive sealant is connected with the connection portion.

12. The display panel according to claim 6, wherein the array substrate further includes a lead wire, the lead wire extends to the side of the sealant portion, which faces away from the sealed space, and the lead wire forms the connection portion.

13. The display panel according to claim 5, wherein the bonding portion includes a conductive adhesive, and the connection portion includes conductive foam.

14. A display apparatus, comprising the display panel according to claim 1.

15. The display apparatus according to claim 14, further comprising: a conductive frame arranged to surround the display panel,
wherein the black matrix is electrically connected with the conductive frame.

16. A fabrication method of a display panel, comprising:
providing an array substrate and an opposed substrate which are arranged opposite to and bonded with each other; and
forming a conductive black matrix on a side of the opposed substrate,
wherein the black matrix is electrically connected with an external circuit.

17. The fabrication method according to claim 16, further comprising:
forming an electromagnetic shielding structure, which includes the black matrix, a bonding portion and a connection portion,
wherein the bonding portion is connected with the black matrix and the connection portion, and the connection portion is connected with the external circuit.

18. The fabrication method according to claim 17, further comprising:
forming a sealant portion between the array substrate and the opposed substrate,
wherein a sealed space is formed by the sealant portion, the opposed substrate and the array substrate.

19. The fabrication method according to claim 18, wherein the forming the electromagnetic shielding structure includes:
forming the black matrix to extend to a side of the sealant portion, which faces away from the sealed space;
forming the bonding portion on the side of the sealant portion, which faces away from the sealed space, and connecting the bonding portion with the black matrix; and
forming the connection portion on a side of the bonding portion, which faces away from the sealant portion.
